(19) United States
(12) Patent Application Publication
(10) Pub. No.: US 2026/0200483 A1
(43) Pub. Date: Jul. 16, 2026

(54) AUTOMATED VALET PARKING SYSTEM, HANDLING METHOD FOR HANDLING PROBLEM OCCURRING IN AUTOMATED VALET PARKING SYSTEM, AND STORAGE MEDIUM

(71) Applicant: TOYOTA JIDOSHA KABUSHIKI KAISHA, Toyota-shi (JP)

(72) Inventors: Kazuhito ESHIMA, Toyota-shi (JP); Hidenobu Kinugasa, Nagoya-shi (JP); Takahiro Yamamoto, Toyota-shi (JP); Tatsuya Sugano, Seto-shi (JP)

(73) Assignee: TOYOTA JIDOSHA KABUSHIKI KAISHA, Toyota-shi (JP)

(21) Appl. No.: 19/419,594

(22) Filed: Dec. 15, 2025

(30) Foreign Application Priority Data
Jan. 10, 2025 (JP) 2025-003900

(51) Int. Cl. B60W 50/02; B60W 30/06; B60W 50/14; G07C 5/00

(52) U.S. Cl. CPC B60W 50/0225; B60W 30/06; B60W 50/14; G07C 5/008; B60W 2556/45

(57) ABSTRACT

When a problem occurs in automated valet parking, the processing circuit of the automated valet parking system interrupts automated valet parking, notifies the user of the problem to the user of the relevant vehicle, sets the length of the window time according to the severity of the problem, waits for an instruction from the user until the window time elapses, and stops the automated valet parking after the lapse of the window time.

### CROSS-REFERENCE TO RELATED APPLICATION

This application claims priority to Japanese Patent Application No. 2025-003900 filed on January 10, 2025. The disclosure of the above-identified application, including the specification, drawings, and claims, is incorporated by reference herein in its entirety.

### BACKGROUND

### 1. Technical Field

The present disclosure relates to an automated valet parking system, a handling method for handling a problem occurring in the automated valet parking system, and a storage medium.

### 2. Description of Related Art

DE-A 102012222562 discloses a system for automated valet parking in which a vehicle that has acquired route information from a parking lot side performs unmanned traveling from a starting position to a target position.

### SUMMARY

Typically, an automated valet parking system interrupts automated valet parking of a vehicle when a problem occurs in the traveling of the vehicle, and then notifies a user of the occurrence of the problem and waits for the user to respond. The problem is handled in accordance with an instruction from the user, but when there is no instruction from the user even after a certain amount of time has elapsed, the system stops the automated valet parking that is currently interrupted. When this certain amount of time is set uniformly, this may cause trouble for the user or an operator of a parking lot.

A system according to an embodiment of the present disclosure is an automated valet parking system for providing automated valet parking to a relevant vehicle, the automated valet parking system including

a processing circuit.

The processing circuit is configured to, when a problem has occurred in the automated valet parking,

interrupt the automated valet parking and notify a user of the relevant vehicle of occurrence of the problem,

set a length of a window time in accordance with severity of the problem,

wait for an instruction from the user until the window time elapses,and

stop the automated valet parking upon the window time elapsing.

A method according to an embodiment of the present disclosure is a handling method for handling a problem occurring in an automated valet parking system that provides automated valet parking to a relevant vehicle, the handling method including

causing a computer to execute, when a problem occurs in the automated valet parking,

interrupting the automated valet parking,

notifying a user of the relevant vehicle of occurrence of the problem,

setting a length of a window time in accordance with severity of the problem,

waiting for an instruction from the user until the window time elapses, and

stopping the automated valet parking upon the window time elapsing.

According to the present disclosure, when a problem occurs in automated valet parking, setting a window time in accordance with severity of the problem enables both a user and an operator of a parking lot to smoothly handle the problem.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an automated valet parking system;

FIG. 2 is a diagram illustrating the flow of information in an automated valet parking system;

FIG. 3 is a diagram illustrating a relationship between the severity of a problem, a window time, and options;

FIG. 4 is a diagram illustrating an exemplary display of a user terminal; and

FIG. 5 is a flowchart illustrating a flow of processing by the infrastructure computer.

### DETAILED DESCRIPTION OF EMBODIMENTS

### 1.Configuring an automated valet parking System

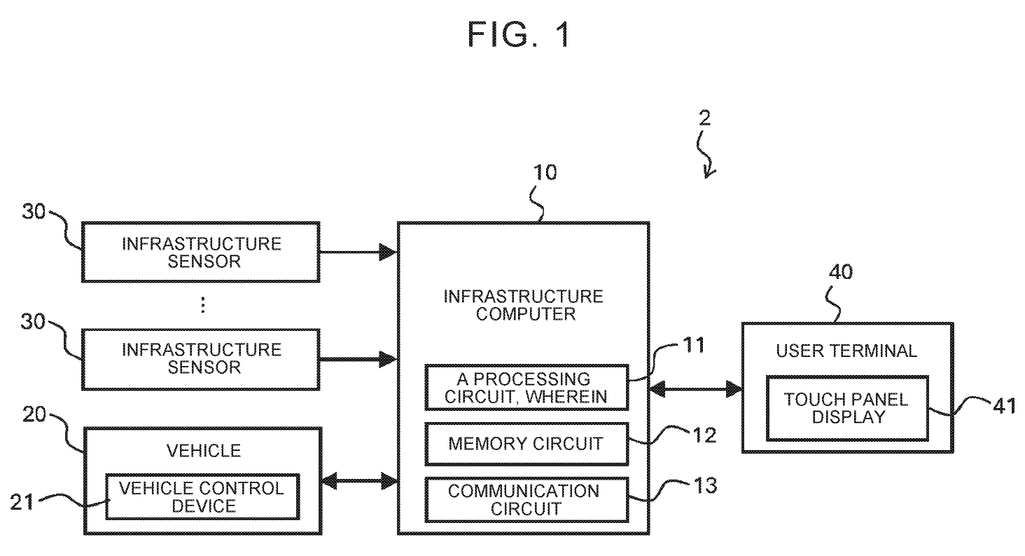

FIG. 1 shows a configuration of an automated valet parking system 2 according to the present embodiment. The automated valet parking system 2 comprises an infrastructure computer 10 that manages and controls automated valet parking for the vehicle 20.

The infrastructure computer 10 may be a physical server, a cloud server, or a combination of a physical server and a cloud server. Infrastructure computer 10 is connected to a plurality of infrastructure sensors 30 located in a parking lot. The infrastructure sensor 30 is a sensor that acquires information on various states of the automated valet parking system 2 including an operation state, a communication state, and a safety state. The infrastructure sensor 30 includes a surveillance camera disposed along a road on which the vehicle 20 travels. The infrastructure computer 10 acquires sensing information for automated valet parking from the infrastructure sensor 30 including a surveillance camera in real time, and performs processing related to automated valet parking based on the sensing information.

The infrastructure computer 10 includes a processing circuit 11, a storage circuit 12, and a communication circuit 13. The processing circuit 11 is a circuit configured to perform processing related to automated valet parking. The sensing information of the infrastructure sensor 30 is processed by the processing circuit 11. Processing circuit 11 includes one or more processors, such as CPU, FPGA, or ASIC. The storage circuit 12 (storage medium) is a circuit configured to store a program related to automated valet parking and related data thereof. The storage circuit 12 includes one or more primary memories, and may further include one or more secondary storage. The communication circuit 13 is a circuit configured to communicate with the outside. The communication circuit 13 includes a wireless communication module for performing wireless communication and a wired communication module for performing wired communication. The processing circuit 11 is communicably connected to the storage circuit 12 and the communication circuit 13.

The vehicle 20 has a function necessary for automated valet parking including an automated driving function, and is a relevant vehicle to be subjected to automated valet parking. Automated driving of the vehicle 20 in the parking lot is controlled by the infrastructure computer 10. Wireless communication using a wireless LAN is performed between the communication circuit 13 of the infrastructure computer 10 and the vehicle control device 21 mounted on the vehicle 20. Automated driving of the vehicle 20 may be controlled by cooperation of the infrastructure computer 10 and the vehicle control device 21. The vehicle 20 may be an autonomous driving vehicle that can autonomously travel outside the parking lot.

The infrastructure computer 10 is connected to the user terminal 40 via a mobile network via the Internet. Two-way communication is performed between the communication circuit 13 of the infrastructure computer 10 and the user terminal 40. The user terminal 40 is typically a smartphone. The user terminal 40 includes a touch panel display 41 as an input/output interface.

### 2. Processing performed by the automated valet parking system

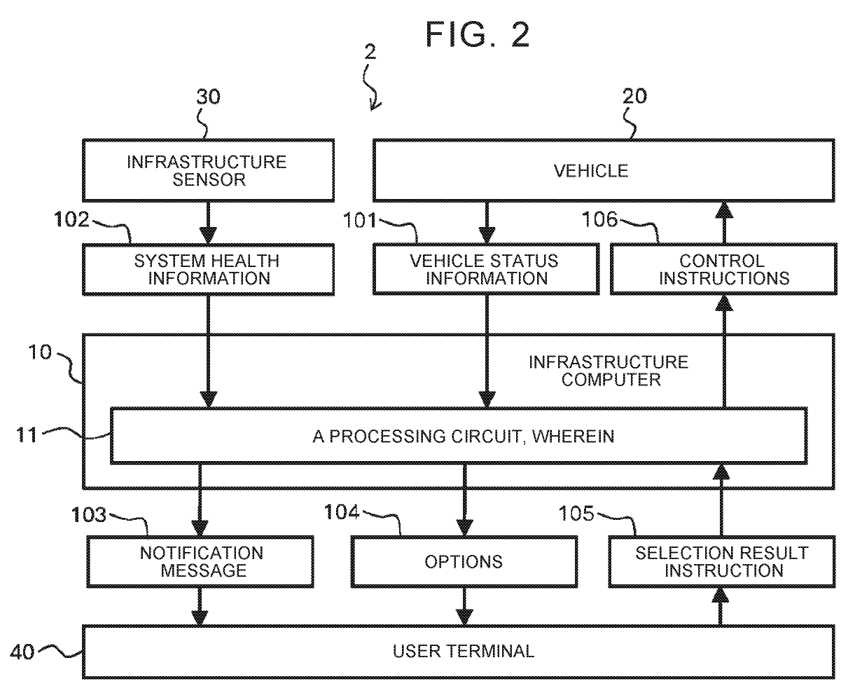

FIG. 2 is a diagram illustrating a flow of information in the automated valet parking system 2. Processing executed by the automated valet parking system 2 will be described with reference to the drawings.

The vehicle state information 101 acquired by various sensors mounted on the vehicle 20 is transmitted from the vehicle 20 to the infrastructure computer 10. Vehicle status information 101 includes various warning information such as, for example, engine warning, hydraulic warning, PCS warning, EPS warning, ABS warning, pneumatic warning, half-door warning, SOC warning, and fuel-remaining warning. The vehicle state information 101 includes obstacle information acquired by the outside camera and information acquired by monitoring by the inside camera.

The system state information 102 acquired by the infrastructure sensor 30 is transmitted from the infrastructure sensor 30 to the infrastructure computer 10. The system state information 102 includes, for example, information regarding a malfunction of the communication device, information regarding a malfunction of the camera, and information regarding an intrusion of a pedestrian into the travel route.

In the infrastructure computer 10, the vehicle state information 101 and the system state information 102 are processed by the processing circuit 11. Based on the vehicle state information 101 and the system state information 102, the processing circuit 11 detects occurrence of a problem that hinders the continuation of automated valet parking. What is a "problem" is defined in advance, and the severity is determined according to the content of the problem. A problem in which the influence is limited to only the vehicle 20 is considered to be a problem of low severity. Conversely, the problem affecting the entire automated valet parking system 2 is considered to be a serious problem. Therefore, if the following vehicle can secure a traveling route that bypasses the failed vehicle, the failure is detected as a relatively low-severity problem. However, even in the case of a failure of the same vehicle, if the following vehicle cannot secure a detour, the failure is detected as a problem of relatively high severity.

When a problem occurs in the vehicle 20, the processing circuit 11 transmits a control instruction 106 to the vehicle 20, and interrupts the provision of automated valet parking to the vehicle 20. When the automated valet parking is interrupted, the processing circuit 11 transmits a message 103 notifying the user of the vehicle 20 that has interrupted the automated valet parking of the occurrence of the problem. Further, in conjunction with the transmission of the message 103, the processing circuit 11 presents the user with an option 104 to address the problem.

The message 103 transmitted from the infrastructure computer 10 to the user is displayed on the touch panel display 41 of the user terminal 40. The options 104 presented by the infrastructure computer 10 are also displayed on the touch panel display 41. The infrastructure computer 10 sets the length of window time to wait for an instruction from the user depending on the severity of the problem. If a window time has elapsed before an instruction from the user arrives, a control instruction 106 is again transmitted to the vehicle 20 in which the problem has occurred, and the provision of automated valet parking for the vehicle 20 is switched from "interrupted" to "stopped"

When the user selects an option displayed on the touch panel display 41, the selection result is transmitted to the infrastructure computer 10 as an instruction 105 from the user and is input to the processing circuit 11. When the instruction 105 of the selection result from the user is input to the processing circuit 11 before the window time elapses, the processing circuit 11 executes the processing according to the instructed selection result.

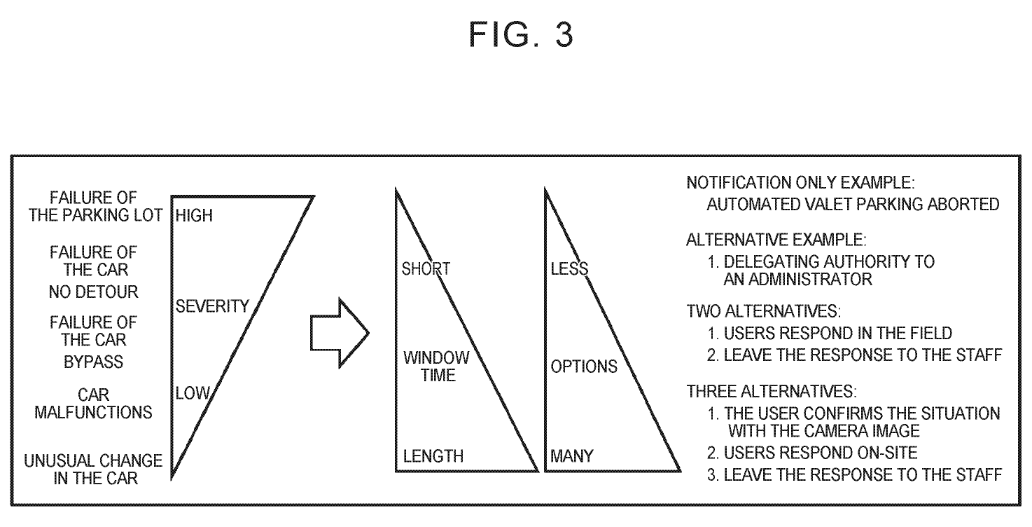

FIG. 3 is a diagram illustrating a relationship between a severity of a problem, a window time, and an option. If the problem is low in severity, the window time may be longer, but as the severity is higher, the window time may be shorter. As a specific example, the seriousness of the problem is increased in the order of an abnormal change in the vehicle, a malfunction of the vehicle, a case in which there is no bypass circuit that bypasses the vehicle due to a failure of the vehicle, a case in which there is no bypass circuit that bypasses the vehicle due to a failure of the vehicle, and a failure of the parking lot. In this case, the window time is set to be the longest is an abnormal change in the vehicle interior, and the window time is set to be the shortest is a failure in the parking lot. In the storage circuit 12 of the infrastructure computer 10, a table in which a window time is associated with the content of the problem is registered. The processing circuit 11 of the infrastructure computer 10 refers to the table and sets the length of the window time.

The number of options presented to the user terminal 40 from the infrastructure computer 10 decreases with increasing severity. That is, the higher the severity of the problem, the shorter the window time and the fewer choices the user can take. For example, there are three options for the lowest severity of the problem: the user confirms the situation with the camera image, the user responds on the site, and the staff is allowed to respond. As the severity of the problem increases, there are two choices, and the user is offered the option of responding in the field and leaving the response to the staff. As the severity of the problem increases further, there is only one option, and only the option of delegating authority to the administrator is presented. In the case of the highest severity, the automated valet parking is immediately stopped, and only the fact that the automated valet parking is stopped is notified to the user terminal 40.

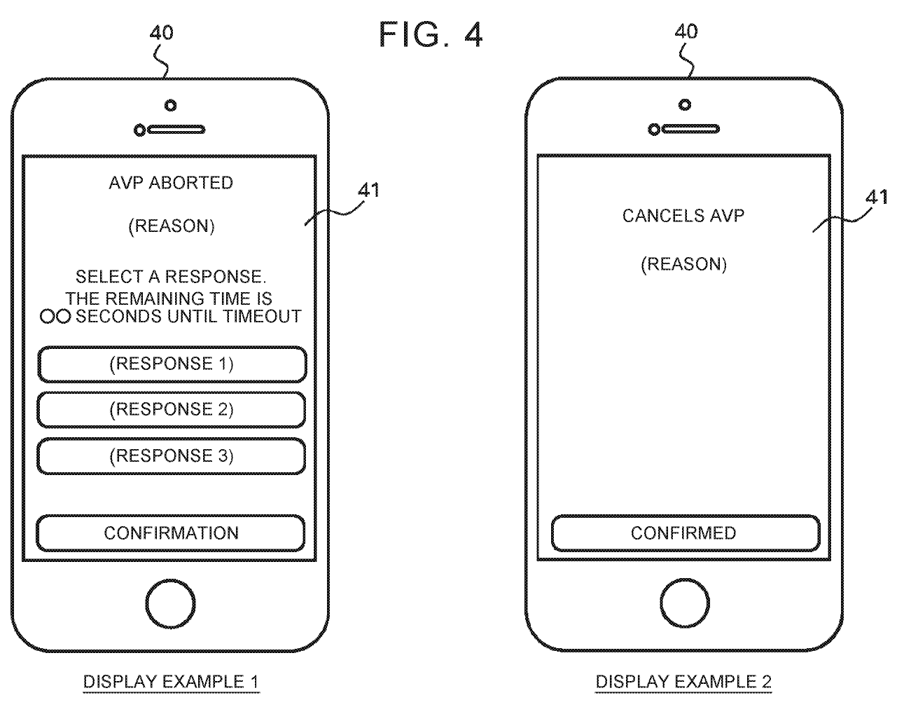

FIG. 4 is a diagram illustrating a display example of the touch panel display 41 of the user terminal 40. As shown in the display example 1, on the touch panel display 41, a message indicating that the automated valet parking has been interrupted is displayed, and a number of selection buttons corresponding to the severity of the problem and a confirmation button for confirming the selection result are displayed. Although the description is omitted in the display example 1, the details of the specific correspondence are displayed in (correspondence 1) (correspondence 2) (correspondence 3) of the option button. Further, on the touch panel display 41, the window time set by the infrastructure computer 10 is displayed as the remaining time until the reply.

The display example 2 is a display example of the touch panel display 41 in a case where the severity of the problem is highest. In this case, the touch panel display 41 displays a message indicating that the automated valet parking is to be stopped, and a confirmation button for notifying the infrastructure computer 10 that the user has confirmed the automated valet parking is displayed.

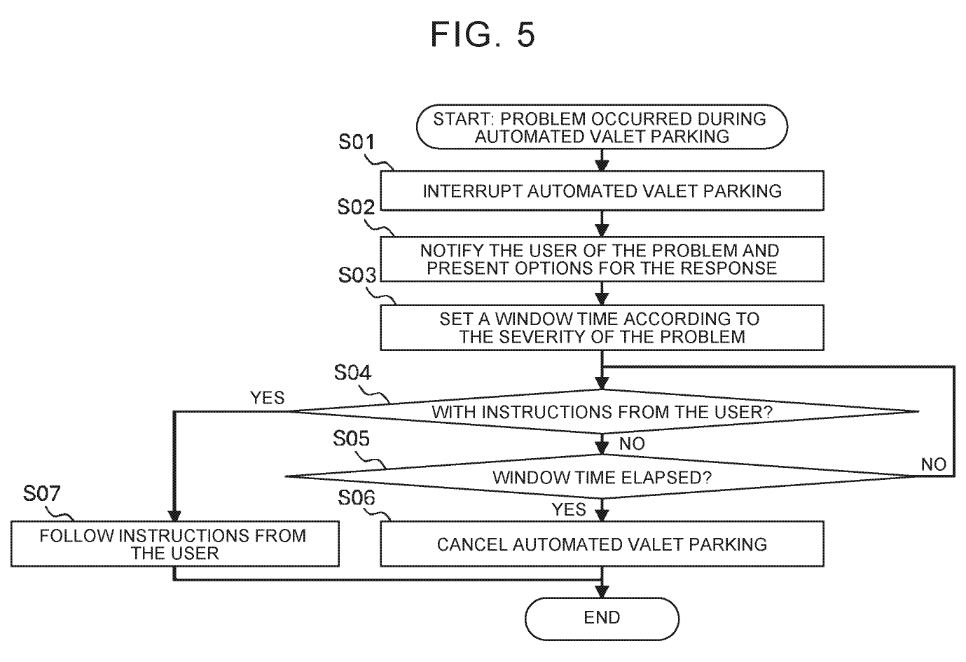

FIG. 5 is a flowchart illustrating a flow of processing performed by the infrastructure computer 10. This flowchart is also a flowchart showing a handling method when a problem occurs in the automated valet parking system according to the present embodiment. The program stored in the storage circuit 12 of the infrastructure computer 10 includes a plurality of instructions for causing the processing circuit 11 to execute the method shown in this flowchart.

This flowchart is initiated in response to a problem occurring during automated valet parking. First, in S01, the processing circuit 11 interrupts automated valet parking for the currently running vehicles 20. After executing S01 process, the processing circuit 11 executes S02 process.

In S02, the processing circuit 11 notifies the user who has deposited the vehicles 20 in the parking lot of the occurrence of the problem and presents an option of a response that the user can take. The association between the user terminal 40 carried by the user and the vehicle 20 is performed at the time of use registration of the parking lot. After executing S02 process, the processing circuit 11 executes S03 process.

In S03, the processing circuit 11 sets a window time for waiting for an instruction from the user in accordance with the severity of the problem occurring. After executing S03 process, the processing circuit 11 determines S04.

In S04, the processing circuit 11 determines the presence or absence of an instruction from the user. When the instruction from the user is not received, the processing circuit 11 determines S05. In S05, the processing circuit 11 determines whether the window time has elapsed. The processing circuit 11 repeatedly determines S04 and S05 until an instruction is given by the user or the window time elapses.

When the instruction from the user is received before the window time elapses, the processing circuit 11 executes the processing in accordance with the instruction from the user in S07. If the window time has elapsed without receiving an instruction from the user, the processing circuit 11 stops automated valet parking for the currently interrupted vehicles 20 in S06.

### 3. Effects of the automated valet parking system

As described above, when a problem occurs in automated valet parking, the infrastructure computer 10 interrupts automated valet parking for the vehicle 20 and notifies the user of the occurrence of the problem. at the same time, the length of the window time for waiting for an instruction from the user to the problem is set according to the severity of the problem. specifically, when the severity is high, the window time is shortened to stop the automated valet parking, and when the severity is low, the window time is lengthened to wait as much as possible for an instruction from the user. in this way, when a problem occurs in automated valet parking, by setting a window time according to the severity of the problem, both the user and the operator of the parking lot can smoothly proceed with handling the problem.

What is claimed is:

1. An automated valet parking system for providing automated valet parking to a relevant vehicle, the automated valet parking system comprising a processing circuit, wherein
the processing circuit is configured to, when a problem has occurred in the automated valet parking,
interrupt the automated valet parking,
notify a user of the relevant vehicle of occurrence of the problem,
set a length of a window time in accordance with severity of the problem,
wait for an instruction from the user until the window time elapses, and
stop the automated valet parking upon the window time elapsing.

2. The automated valet parking system according to claim 1, wherein
the severity varies in accordance with each content of the problem, and
the processing circuit is configured to set the length of the window time by referencing a table in which the window time is associated with the content of the problem.

3. The automated valet parking system according to claim 1, wherein
the processing circuit is configured to
present the user with a count of options in accordance with the severity of the problem, and
receive an option that is selected by the user, as the instruction.

4. A handling method for handling a problem occurring in an automated valet parking system that provides automated valet parking to a relevant vehicle, the handling method comprising:
causing a computer to execute, when a problem occurs in the automated valet parking,
interrupting the automated valet parking;
notifying a user of the relevant vehicle of occurrence of the problem;
setting a length of a window time in accordance with severity of the problem;
waiting for an instruction from the user until the window time elapses; and
stopping the automated valet parking upon the window time elapsing.

5. A non-transitory storage medium storing a program including a plurality of instructions for causing a computer to execute the handling method according to claim 4.
